(19) United States
(12) Patent Application Publication
(10) Pub. No.: US 2026/0323628 A1
(43) Pub. Date: Oct. 15, 2026

(54) METHODS AND DEVICES FOR GENERATING AND TRANSMITTING SCHEDULING REQUEST UNDER AGGREGATION TRANSMISSION

(71) Applicant: ZTE CORPORATION, Shenzhen, Guangdong (CN)

(72) Inventors: Wei GOU, Shenzhen (CN); Xianghui HAN, Shenzhen (CN); Shuaihua KOU, Shenzhen (CN)

(21) Appl. No.: 19/484,175

(22) PCT Filed: Jul. 7, 2023
(86) PCT No.: PCT/CN2023/106402

§ 371 Date: Nov. 13, 2025

(51) Int. Cl. H04W 72/1263; H04W 72/21

(52) U.S. Cl. CPC H04W 72/1263; H04W 72/21

(57) ABSTRACT

The present disclosure describes methods, system, and devices for generating and transmitting scheduling request (SR) under user equipment (UE) aggregation transmission. The method includes receiving a shared scheduling request (SR) configuration, wherein the first UE and the second UE are paired for the UE aggregation transmission; configuring shared SR resources corresponding to the shared SR configuration; forming SR information according to scheduled requirement status of at least one of the first UE and the second UE; determining an SR sequence based on the SR information; and transmitting the SR sequence in a SR resource from the shared SR resources.

### CROSS-REFERENCE TO RELATED APPLICATION(S)

The present application is a national phase entry under 35 U.S.C 371 of International Application No. PCT/CN2023/106402, filed on Jul. 7, 2023. The entire contents of the International Patent Application are incorporated herein by reference.

### TECHNICAL FIELD

The present disclosure is directed generally to wireless communications. Particularly, the present disclosure relates to methods and devices for generating and transmitting scheduling request (SR) under user equipment (UE) aggregation transmission.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

In some wireless communication schemes, user equipment (UE) aggregation transmission may be used to improve throughout or reliability of transmission from a UE, for example, when the UE is at a cell edge of a base station. There are many problems/issues associated with operations of UE aggregation transmission. For example, at least one problem/issue may be related to how to generate and/or transmit scheduling request (SR) under the UE aggregation transmission.

The present disclosure describes various embodiments for generating and transmitting scheduling request (SR) under UE aggregation transmission, addressing at least one of the issues/problems discussed above, improving performance of the wireless communication, particularly achieving efficient generation and/or transmission of SR under UE aggregation transmission and/or improving throughput and/or reliability of UE's transmission.

### SUMMARY

This document relates to methods, systems, and devices for wireless communication, and more specifically, for generating and transmitting scheduling request (SR) under UE aggregation transmission. The various embodiments in the present disclosure may increase the resource utilization efficiency, enhance coverage, and/or improve throughput and/or reliability of UE's transmission.

In one embodiment, the present disclosure describes a method for wireless communication. The method includes receiving, by at least one of a first UE and a second UE from a base station, a shared scheduling request (SR) configuration, wherein the first UE and the second UE are paired for the UE aggregation transmission; configuring, by at least one of the first UE and the second UE, shared SR resources corresponding to the shared SR configuration; forming, by at least one of the first UE and the second UE, SR information according to scheduled requirement status of at least one of the first UE and the second UE; determining, by at least one of the first UE and the second UE, an SR sequence based on the SR information; and transmitting, by at least one of the first UE and the second UE to the base station, the SR sequence in a SR resource from the shared SR resources.

In one embodiment, the present disclosure describes a method for wireless communication. The method includes sending, by a base station to at least one of a first UE and a second UE, a shared SR configuration to configure shared SR resources, wherein the first UE and the second UE are paired for the UE aggregation transmission; and receiving, by the base station from at least one of the first UE and the second UE, a SR sequence in a SR resource from the shared SR resources, wherein the at least one of the first UE and the second UE forms SR information according to scheduled requirement status of at least one of the first UE and the second UE, and determines the SR sequence based on the SR information.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium includes a non-transitory computer-readable medium.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4A shows a flow diagram of an exemplary method for wireless communication.

FIG. 4B shows a flow diagram of another exemplary method for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for generating and transmitting scheduling request (SR) under user equipment (UE) aggregation transmission.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

In some wireless communication schemes, user equipment (UE) aggregation transmission may be used to improve throughout or reliability of transmission from a UE, for example, when the UE is at a cell edge of a base station. There are many problems/issues associated with operations of UE aggregation transmission. For example, at least one problem/issue may be related to how to generate and/or transmit scheduling request (SR) under the UE aggregation transmission.

The present disclosure describes various embodiments for generating and transmitting scheduling request (SR) under UE aggregation transmission, addressing at least one of the issues/problems discussed above, improving performance of the wireless communication, particularly achieving efficient generation and/or transmission of SR under UE aggregation transmission and/or improving throughput and/or reliability of UE's transmission.

In some implementations, the UE aggregation transmission may be divided into a plurality of modes, for example, a transparent mode and a non-transparent mode. In the transparent mode, the base station may be unaware that a group of UEs (e.g., a first UE (UE1) and a second UE (UE2)) are paired for UE aggregation transmission. In the non-transparent mode, the base station knows that the group of UEs are paired for UE aggregation transmission, and knows that one UE's data may be transmitted by another UE, for example, the base station may know that the UE1's data may be transmitted by the UE2.

In some implementations, transparent mode may have some drawbacks that lead to inefficiency. For one non-limiting example, a channel environment (such as channel state information (CSI), interference, etc.) of the UE1 and the UE2 may be different. The base station may not be aware that the UE1 and the UE2 are paired to perform the UE aggregation transmission, and thus, the base station may always configure parameter values in the UE1's uplink (UL) grant based on the UE1's channel environment. The UE1's data is ultimately transmitted by the UE2 based on the UE2's channel environment. Obviously, in this case, when the UE1's data is transmitted by the UE2, the parameters matching UE2's channel environment are not used and it may lead to inefficiency.

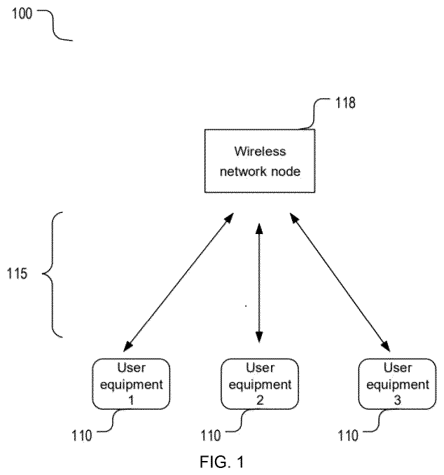

FIG. 1 shows a wireless communication system 100 including a wireless network node 118 (also referred to as network base station 118) and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

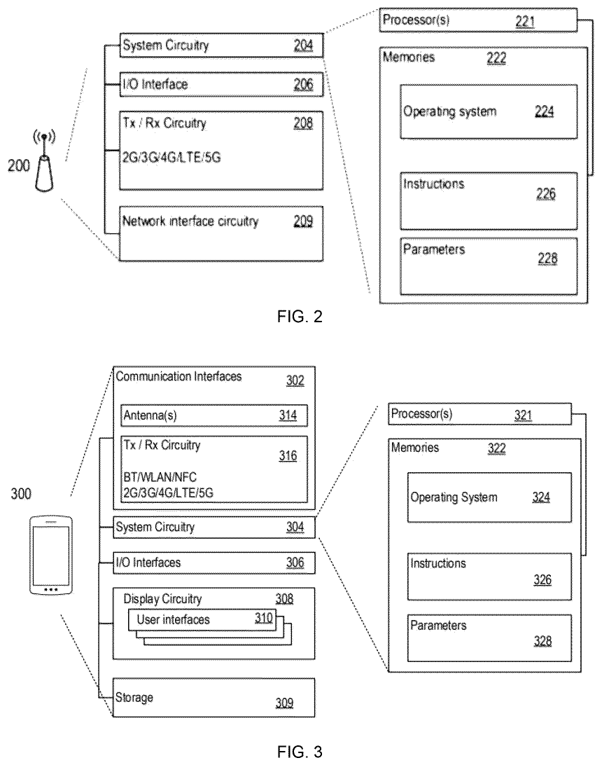

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

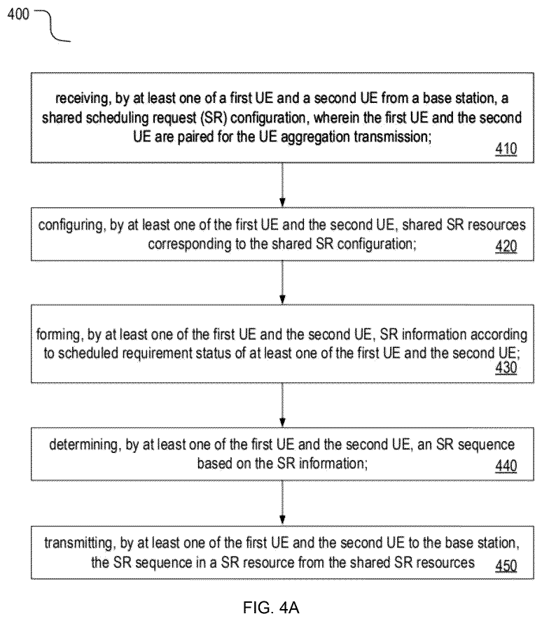

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, 6G standards, or any other telecommunication standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for forming measurement results under user equipment (UE) aggregation transmission, which may be implemented, partly or totally, on the network base station and/or the user equipment described above in FIGS. 2-3.

In various embodiments in the present disclosure, when a group of UEs are in UE aggregation transmission, each UE in the group may have its role type.

For one non-limiting example, when a first UE (UE1) and a second UE (UE2) are paired for UE aggregation transmission, the UE1's data is transmitted to the base station by the UE2, and the UE2's data is not transmitted to the base station by the UE1, the UE1 and the UE2 may represent different role types: the UE1 may have a role type of an anchor UE and the UE2 may have a role type of an assistant UE. In some implementations, the UE1's data may include UE1's uplink control information (UCI), for example, hybrid automatic repeat request acknowledgement (HARQ-ACK), scheduling request (SR), channel state information (CSI), etc.

For another non-limiting example, when a first UE (UE1) and a second UE (UE2) are paired for UE aggregation transmission, the UE1's data is transmitted to the base station by the UE2, and the UE2's data is transmitted to the base station by the UE1, the UE1 and the UE2 may represent a role type of mutual UEs: the UE1 may have a role type of an anchor UE and a role type of an assistant UE; and the UE2 may have a role type of an assistant UE and a role type of an anchor UE.

In various embodiments, the anchor UE and the assistant UE may be called as master UE and slave UE, respectively, or primary UE and secondary UE, respectively.

The present disclosure describes various embodiment for forming measurement results under user equipment (UE) aggregation transmission, at least addressing some of the problems/issues described above, for example, how to generate and/or transmit SR under the UE aggregation transmission.

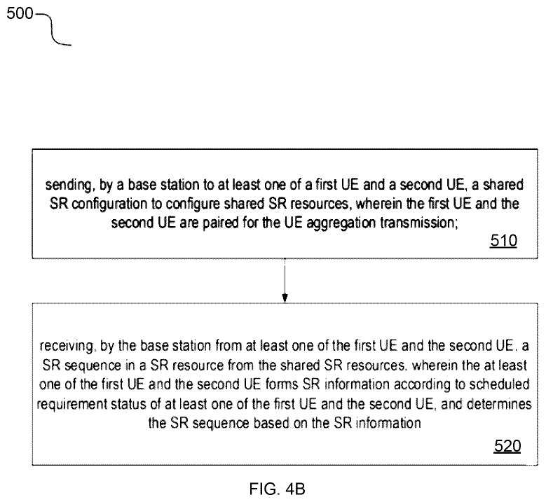

Referring to FIG. 4A, the present disclosure describes various embodiments of a method 400 for wireless communication for generating and transmitting SR under UE aggregation transmission, wherein a first UE and a second UE are paired for the UE aggregation transmission. The method 400 may include a portion or all of the following steps: step 410, receiving, by at least one of a first UE and a second UE from a base station, a shared scheduling request (SR) configuration, wherein the first UE and the second UE are paired for the UE aggregation transmission; step 420, configuring, by at least one of the first UE and the second UE, shared SR resources corresponding to the shared SR configuration; step 430, forming, by at least one of the first UE and the second UE, SR information according to scheduled requirement status of at least one of the first UE and the second UE; step 440, determining, by at least one of the first UE and the second UE, an SR sequence based on the SR information; and/or step 450, transmitting, by at least one of the first UE and the second UE to the base station, the SR sequence in a SR resource from the shared SR resources.

Referring to FIG. 4B, the present disclosure describes various embodiments of a method 500 for wireless communication. The method 500 may include a portion or all of the following steps: step 510, sending, by a base station to at least one of a first UE and a second UE, a shared SR configuration to configure shared SR resources, wherein the first UE and the second UE are paired for the UE aggregation transmission; and step 520, receiving, by the base station from at least one of the first UE and the second UE, a SR sequence in a SR resource from the shared SR resources, wherein the at least one of the first UE and the second UE forms SR information according to scheduled requirement status of at least one of the first UE and the second UE, and determines the SR sequence based on the SR information.

In some implementations, in addition to a portion, an entire, or any combination of the described implementation(s)/embodiment(s), the forming the SR information according to scheduled requirement status of at least one of the first UE and the second UE and the determining the SR sequence based on the SR information comprises: in response to the first UE having scheduled requirement and the second UE not having scheduled requirement, determining, by the first UE, a first pre-configured SR sequence as the first UE's SR sequence; in response to the first UE not having scheduled requirement and the second UE having scheduled requirement, determining, by the second UE, a second pre-configured SR sequence as the second UE's SR sequence; and/or in response to the first UE and the second UE having scheduled requirement, determining, by the first UE and the second UE, a first pre-configured SR sequence as the first UE's SR sequence and a second pre-configured SR sequence as the second UE's SR sequence, respectively.

In some implementations, in addition to a portion, an entire, or any combination of the described implementation(s)/embodiment(s), the step of transmitting the SR sequence in the SR resource from the shared SR resources comprises: in response to the first UE having scheduled requirement and the second UE not having scheduled requirement: transmitting, by the first UE, the first UE's SR sequence in the SR resource, transmitting, by the second UE, the first UE's SR sequence in the SR resource, or transmitting, by the first UE and the second UE simultaneously, the first UE's SR sequence in the same SR resource; and/or in response to the first UE not having scheduled requirement and the second UE having scheduled requirement: transmitting, by the first UE, the second UE's SR sequence in the SR resource, transmitting, by the second UE, the second UE's SR sequence in the SR resource, or transmitting, by the first UE and the second UE simultaneously, the second UE's SR sequence in the same SR resource; and/or in response to the first UE and the second UE having scheduled requirement, transmitting, by the first UE and the second UE, the first UE's SR sequence and the second UE's SR sequence, respectively, in a same or different SR resources.

In some implementations, in addition to a portion, an entire, or any combination of the described implementation(s)/embodiment(s), the base station configures a transmission mode to the first UE and the second UE as one of the following: a first mode wherein the first UE and the second UE transmit the SR sequence simultaneously, a second mode wherein the first UE transmits the SR sequence, or a third mode wherein the second UE transmits the SR sequence.

In some implementations, in addition to a portion, an entire, or any combination of the described implementation(s)/embodiment(s), one transmission mode is configured as a default transmission mode; or at least one UE of the first UE and the second UE requests a transmission mode from the base station.

In some implementations, in addition to a portion, an entire, or any combination of the described implementation(s)/embodiment(s), the step of transmitting the SR sequence in the SR resource comprises: transmitting, by at least one of the first UE and the second UE, the SR sequence based on a physical uplink control channel (PUCCH) format 0.

In some implementations, in addition to a portion, an entire, or any combination of the described implementation(s)/embodiment(s), the step of transmitting the SR sequence in the SR resource comprises: modulating, by at least one of the first UE and the second UE, the SR sequence to obtain a modulated SR sequence; and/or transmitting, by at least one of the first UE and the second UE, the modulated SR sequence based on a PUCCH format 1.

In some implementations, in addition to a portion, an entire, or any combination of the described implementation(s)/embodiment(s), the base station determines which one of the first UE and the second UE being an anchor UE based on the transmitting and receiving of corresponding SR request.

In some implementations, in addition to a portion, an entire, or any combination of the described implementation(s)/embodiment(s), the step of forming the SR information according to scheduled requirement status of at least one of the first UE and the second UE and the determining the SR sequence based on the SR information comprises: in response to the first UE having scheduled requirement, determining, by the first UE, a pre-configured SR sequence as the shared SR sequence, wherein the pre-configured SR sequence is configured for the paired first UE and second UE.

In some implementations, in addition to a portion, an entire, or any combination of the described implementation(s)/embodiment(s), the step of transmitting the SR sequence in the SR resource comprises: in response to the first UE having scheduled requirement: transmitting, by the first UE, the shared SR sequence in the SR resource, transmitting, by the second UE, the shared sequence in the SR resource, or transmitting, by the first UE and the second UE simultaneously, the shared SR sequence in the same SR resource.

In some implementations, in addition to a portion, an entire, or any combination of the described implementation(s)/embodiment(s), the base station configures a transmission mode to the first UE and the second UE as one of the following: a first mode wherein the first UE and the second UE transmit the shared SR sequence simultaneously, a second mode wherein the first UE transmits the shared SR sequence, or a third mode wherein the second UE transmits the shared SR sequence.

In some implementations, in addition to a portion, an entire, or any combination of the described implementation(s)/embodiment(s), one transmission mode is configured as a default transmission mode; or at least one UE of the first UE and the second UE requests a transmission mode from the base station.

In some implementations, in addition to a portion, an entire, or any combination of the described implementation(s)/embodiment(s), the step of transmitting the SR sequence in the SR resource comprises: transmitting, by at least one of the first UE and the second UE, the shared SR sequence based on a PUCCH format 0.

In some implementations, in addition to a portion, an entire, or any combination of the described implementation(s)/embodiment(s), the step of transmitting the SR sequence in the SR resource comprises: modulating, by at least one of the first UE and the second UE, the shared SR sequence to obtain a modulated shared SR sequence; and transmitting, by at least one of the first UE and the second UE, the modulated shared SR sequence based on a PUCCH format 1.

In some implementations, in addition to a portion, an entire, or any combination of the described implementation(s)/embodiment(s), the step of forming the SR information according to scheduled requirement status of at least one of the first UE and the second UE comprises: determining, by at least one of the first UE and the second UE, a first bit based on the scheduled requirement status of the first UE and a second bit based on the scheduled requirement status of the second UE; and/or forming, by at least one of the first UE and the second UE, the SR information based on the first bit and the second bit according to a cell-radio network temporary identifier (C-RNTI) of the first UE and the second UE.

In some implementations, in addition to a portion, an entire, or any combination of the described implementation(s)/embodiment(s), in response to the first UE having scheduled requirement, the first bit is 1; in response to the first UE not having scheduled requirement, the first bit is 0; in response to the second UE having scheduled requirement, the second bit is 1; and/or in response to the second UE not having scheduled requirement, the second bit is 0.

In some implementations, in addition to a portion, an entire, or any combination of the described implementation(s)/embodiment(s), in response to the C-RNTI of the first UE being smaller than the C-RNTI of the second UE: in response to the first UE not having scheduled requirement and the second UE having scheduled requirement, the SR information comprises two bits of 01; in response to the first UE having scheduled requirement and the second UE not having scheduled requirement, the SR information comprises two bits of 10; and in response to the first UE having scheduled requirement and the second UE having scheduled requirement, the SR information comprises two bits of 11.

In some implementations, in addition to a portion, an entire, or any combination of the described implementation(s)/embodiment(s), the step of transmitting the SR sequence in the SR resource comprises: transmitting, by the first UE, the SR sequence in the SR resource, transmitting, by the second UE, the SR sequence in the SR resource, or transmitting, by the first UE and the second UE simultaneously, the SR sequence in the same SR resource.

In some implementations, in addition to a portion, an entire, or any combination of the described implementation(s)/embodiment(s), the base station configures a transmission mode to the first UE and the second UE as one of the following: a first mode wherein the first UE and the second UE transmit the SR sequence simultaneously, a second mode wherein the first UE transmits the SR sequence, or a third mode wherein the second UE transmits the SR sequence.

In some implementations, in addition to a portion, an entire, or any combination of the described implementation(s)/embodiment(s), one transmission mode is configured as a default transmission mode; or at least one UE of the first UE and the second UE requests a transmission mode from the base station.

In some implementations, in addition to a portion, an entire, or any combination of the described implementation(s)/embodiment(s), the step of determining the SR sequence based on the SR information comprises: determining the SR sequence based an initial sequence index and a sequence cyclic shift, wherein the initial sequence index is configured by the base station and the sequence cyclic shift is determined based on the SR information.

In some implementations, in addition to a portion, an entire, or any combination of the described implementation(s)/embodiment(s), the step of transmitting the SR sequence in the SR resource comprises: transmitting, by at least one of the first UE and the second UE, the SR sequence based on a PUCCH format 0.

In some implementations, in addition to a portion, an entire, or any combination of the described implementation(s)/embodiment(s), the step of determining the SR sequence based on the SR information comprises: modulating, by at least one of the first UE and the second UE, the SR information by using a quadrature phase shift keying (QPSK) scheme to obtain a modulated SR information; and/or modulating, by at least one of the first UE and the second UE, the modulated SR information to obtain a modulated SR sequence.

In some implementations, in addition to a portion, an entire, or any combination of the described implementation(s)/embodiment(s), the step of transmitting the SR sequence in the SR resource comprises: transmitting, by at least one of the first UE and the second UE, the modulated SR sequence based on a PUCCH format 1.

In some implementations, in addition to a portion, an entire, or any combination of the described implementation(s)/embodiment(s), the shared SR resources are configured to comprise at least one of the following: the first UE is configured with at least one set of SR resources based on the SR configuration, and the second UE is configured to share the configured SR resources of the first UE as a default configuration; the first UE is configured with at least one set of SR resources based on the SR configuration, and the second UE is configured to share the configured SR resources of the first UE via a signalling from the base station; the first UE is configured with at least one set of SR resources based on the SR configuration, and the second UE is configured with the same SR resources as the first UE via a signalling from the base station; or the first UE and the second UE are configured with a common set of SR resources via a radio resource control (RRC) signalling from the base station.

In some implementations, in addition to a portion, an entire, or any combination of the described implementation(s)/embodiment(s), in response to the first UE's PUCCH and physical uplink shared channel (PUSCH) overlapping in a time domain, wherein the first UE's PUCCH comprises uplink control information (UCI): the first UE transmits the first UE's PUCCH, and the second UE transmits the first UE's PUSCH; the first UE transmits the first UE's PUSCH, and the second UE transmits the first UE's PUCCH; the second UE transmits a multiplexed PUSCH, which is obtained by multiplexing the UCI in the first UE's PUCCH in the first UE's PUSCH; or the first UE and the second UE simultaneously transmit a multiplexed PUSCH, which is obtained by multiplexing the UCI in the first UE's PUCCH in the first UE's PUSCH; and/or in response to the first UE's PUCCH and PUSCH overlapping in a time domain, wherein the first UE's PUCCH comprises uplink control information (UCI) and the first UE's PUCCH and PUSCH have different priorities: the first UE transmits the first UE's PUCCH, and the second UE transmits the first UE's PUSCH; the first UE transmits the first UE's PUSCH, and the second UE transmits the first UE's PUCCH; the first UE transmits a channel with lower priority between the first UE's PUCCH and PUSCH, and the second UE transmits another channel with higher priority between the first UE's PUCCH and PUSCH; or the first UE transmits a channel with higher priority between the first UE's PUCCH and PUSCH, and the second UE transmits another channel with lower priority between the first UE's PUCCH and PUSCH.

In various embodiments, a group of aggregated UEs (for example, a paired UEs) communicated with a corresponding base station may perform generating and transmitting SR under UE aggregation. In some implementations for non-limiting example, the paired UEs includes a first UE (UE1) and a second UE (UE2), and the UE1's data (e.g., including uplink control information) may be transmitted to a base station by the UE2, i.e., the UE1 is an anchor UE and the UE2 is an assistant UE. In some implementations, the base station knows that UE1 and UE2 are paired for UE aggregation transmission, and UE1's data is transmitted to the base station by the UE2.

### Embodiment Set I

In some embodiments, the paired UE1 and UE2 are configured to share a SR configuration and share SR resources corresponding to the SR configuration. The UE1 and/or UE2 may determine and transmit an SR sequence corresponding to the SR information of the UE1 and/or UE2 in an SR resource from the configured SR resources. The SR sequence may indicate that the UE1 and/or UE2 have scheduled requirements.

Specifically, one method may include the following. When the UE1 and/or UE2 have scheduled requirement, the UE1 or UE2 forms SR information based on the predefined rules, determines a corresponding SR sequence (for example, marked as m) based on the status of the formed SR information and the configured sequence (for example, marked as m₀), and transmits the determined sequence in an SR resource from the shared SR resources.

In some implementations, after the base station receives and parses the determined sequence, one of the following three situations can be obtained: 1) UE1 has no scheduled requirement, but UE2 has the scheduled requirement, 2) UE1 has the scheduled requirement, but UE2 has no scheduled requirement, or 3) UE1 and UE2 both have the scheduled requirements.

In some implementations, when the base station does not receive the determined sequence, the base station may consider the requirement that neither UE1 nor UE2 is scheduled, that is, neither UE1 nor UE2 needs to be scheduled. Correspondingly, when both UE1 and UE2 have no scheduled requirements, UE1 and UE2 do not transmit the determined sequence in the SR resource.

In some implementations, the SR information for no more than 2 UEs may be formed based on one of the following predefined rules. In some implementations, each paired UE corresponds to 1 bit, “0” indicates that the UE has no scheduled requirements, and “1” indicates that the UE has scheduled requirements. In some implementations, vice versa, i.e., “1” indicates that the UE has no scheduled requirements, and “0” indicates that the UE has scheduled requirements.

In some implementations, the SR information bits of paired UEs may be concatenated based on the roles of the paired UEs, or based on the C-RNTI of the paired UEs. For example, the SR information bit corresponding to anchor UE is placed before (or after) the SR information bit corresponding to assistant UE. For another example, the SR information bits corresponding to anchor UE and assistant UE are concatenated in ascending (or descending) order based on the paired UEs' C-RNTI.

For a non-limiting example, when the SR information is formed based on the ascending order of C-RNTI of paired UEs, and when the C-RNTI of UE1 is smaller than the C-RNTI of UE2, the formed SR information includes at least one of the following three situations: ‘01’ indicates that UE1 has no scheduled requirement, but UE2 has the scheduled requirement; “10” indicates that UE1 has the scheduled requirement, but UE2 has no scheduled requirement; and/or ‘11’ indicates that UE1 has the scheduled requirement, and UE2 also has the scheduled requirement.

In some implementations, SR sequence may be determined according to one of the following rules.

In some implementations, the base station and UEs agree that each of the above three situations corresponds to an SR sequence. That is to say, at least three SR sequences need to be determined to correspond to the above three situations. Alternatively, the base station may configure an initial sequence index (m₀) for paired UEs through signaling, and the UE determines a corresponding sequence cyclic shift (m_{cs}) based on the formed SR information according to Table 1. The UE1 and/or the UE2 determines the final SR sequence (for example, marked as m) for the formed SR information based on the initial sequence index (m₀) and sequence cyclic shift (m_{cs}), for a non-limiting example, based on the sum, i.e., m=m₀+m_{cs}. The UE1 and/or the UE2 transmits the final SR sequence in the SR resource.

For a non-limiting example, when there are 12 sequences and the index is between 0 and 11, inclusive, the range of m₀ is between 0 and 3, inclusive. The “3” is obtained by dividing the total number of sequences by the total number of states of the SR information of the paired UE.

In some implementations, the base station receives the final SR sequence in the SR resource. The base station can obtain the formed SR information based on the final SR sequence index and the configured m₀ according to Table 1. The base station parses the formed SR information, e.g., based on the C-RNTI ascending order of the paired UEs. The base station determines the scheduled requirements of the UE1 and/or UE2.

TABLE 1
Mapping relationship between formed SR information and m_{cs}

| SR status of paired UE | {0 1} | {1 1} | {1 0} |
|---|---|---|---|
| Sequence cyclic shift (m_{cs}) | m_{CS} = 0 | m_{CS} = 4 | m_{CS} = 8 |

In some implementations, the base station can configure at least three SR sequences for the above three situations through signaling.

In Table 1, the index interval of SR sequences corresponding to different formed SR information is at least 4, which can obtain the maximum Euclidean distance for a total of 12 sequences. It can reduce mutual interference.

In some implementations, when 12 sequences are used with indices ranging from 0 to 11, 4 sequence groups can be determined based on Table 1 and configured with different m₀, which are {0,4,8}, {1,5,9}, {2,6,10}, and {3,7,11}, respectively.

In some implementations, when there are four paired UEs that need to transmit their respective SR sequences, for example, UE1 and UE2 are paired for UE aggregation transmission, UE3 and UE4 are paired for UE aggregation transmission, UE5 and UE6 are paired, and UE7 and UE8 are paired. In order to save SR resources, the base station can configure the four paired UEs to use the same SR resources, and may configure different m₀ for each of the four paired UEs. For example, m₀=0 is configured for UE1 and UE2, m₀=1 is configured for UE3 and UE4, m₀=2 is configured for UE5 and UE6, and m₀=3 is configured for UE7 and UE8. In this way, based on Table 1, the sequence group used by UE1 and UE2 is {0,4,8}, the sequence group used by UE3 and UE4 is {1,5,9}, the sequence group used by UE5 and UE6 is {2,6,10}, and the sequence group used by UE7 and UE8 is {3,7,11}.

In some implementations, the base station and UE may predefine which sequence group is used as a paired UE, or the base station notifies the UE through signaling which sequence group is used as a paired UE.

In some implementations, the SR sequence is transmitted in the SR resource based on PUCCH format 0.

In some implementations, the UE1 and UE2 need to interact with each other's SR information.

In some implementations, SR sequences may be transmitted simultaneously.

Alternatively, UE1 and UE2 can simultaneously transmit the same determined SR sequence within the same SR resource.

In some implementations, the UE1 and UE2 interact with each other's SR information. The UE1 and UE2 respectively form SR information based on the scheduled requirements of the paired UEs and the predefined rules. UE1 and UE2 respectively determine the final SR sequence through Table 1 based on the configured m₀ and the formed SR information. The UE1 and UE2 simultaneously transmit the final SR sequence in the SR resource. The base station receives and parses the final SR sequence, and obtains one of the three situations mentioned above.

This transmission method may be beneficial for improving the reliability of SR transmission. For example, the paired UEs at the edge of the cell may consider using this transmission method to improve the reliability of SR transmission.

In some implementations, after the UE1 (or UE2) determines the final SR sequence based on the above method, the UE1 (or UE2) may notify the final SR sequence to the UE2 (or UE1), and the UE1 and UE2 simultaneously transmit the final SR sequence in the SR resource.

In some implementations, the base station can configure the transmission mode of the SR sequence in the same SR resource through signaling. For example, the base station can configure the final SR sequence to be transmitted simultaneously by the UE1 and UE2, or the base station can configure the final SR sequence to be transmitted by the UE1 or the UE2. Alternatively, the base station and UE agree that one of the aforementioned transmission modes is executed by default, and then the base station can configure another transmission mode through signaling to replace the default transmission mode.

In some implementations, the UE1 or UE2 may send signaling to the base station to request a certain transmission mode. For example, when paired UEs are located at the edge of the cell, the paired UEs may request UE1 and UE2 to simultaneously transmit the final SR sequence. For example, when the remaining power of UE1 is low, the paired UEs may request only UE2 to transmit the final SR sequence. The base station configures the corresponding transmission modes for UE1 and UE2 based on the request information.

In some implementations, the SR information of paired UEs is transmitted based on PUCCH format 0. Here, the different states of SR information of paired UEs may correspond to different SR sequences respectively. The base station may obtain the state of the SR information of the paired UEs from the received SR sequence through reverse operation.

In some implementations, for more than two UEs in UE aggregation transmission, the SR information of these UEs is also concatenated based on their C-RNTI ascending or descending order. The SR information that is concatenated is modulated to obtain the modulated SR information. The modulated SR information is transmitted in the SR resource based on PUCCH format 2, PUCCH format 3, or PUCCH format 4.

In some implementations, the modulated SR information may be transmitted by one of the paired UEs, or by multiple paired UEs simultaneously within the same SR resource.

### Embodiment Set II

In some embodiments, the paired UE1 and UE2 are configured to share a SR configuration and share SR resources corresponding to the SR configuration. The UE1 and/or UE2 determine and transmit a SR sequence in an SR resource from the configured SR resources, and the SR sequence is modulated by the SR information of UE1 and/or UE2. The SR sequence can indicate that UE1 and/or UE2 have scheduled requirements.

In some implementations, when the UE1 and/or UE2 have a scheduled requirement, the UE1 or UE2 may form the SR information based on the predefined rules, modulates the formed SR information to get the modulated SR information, modulates the modulated SR information into a configured sequence (marked n0) to obtain the modulated sequence, and transmits the modulated sequence in an SR resource from the shared SR resources.

In some implementations, after the base station receives and parses the modulated sequence, one of the following three situations can be obtained: 1) UE1 has no scheduled requirement, but UE2 has the scheduled requirement, 2) UE1 has the scheduled requirement, but UE2 has no scheduled requirement, and/or 3) UE1 and UE2 both have the scheduled requirements.

In some implementations, when the base station does not receive the modulated sequence, the base station considers the requirement that neither UE1 nor UE2 is scheduled, that is, neither UE1 nor UE2 needs to be scheduled. Correspondingly, when both UE1 and UE2 have no scheduled requirements, the UE1 and UE2 do not transmit the modulated sequence in the SR resource.

In some implementations, the SR information for no more than 2 UEs may be formed based on a predefined rules, which may include one of the following. Each paired UE corresponds to 1 bit, “0” indicates that the UE has no scheduled requirements, and “1” indicates that the UE has scheduled requirements; and vice versa. The SR information bits of paired UEs are concatenated based on the roles of the paired UEs, or based on the C-RNTI of the paired UEs. For example, the SR information bit corresponding to anchor UE is placed before (or after) the SR information bit corresponding to assistant UE.

In some implementations, the SR information bits corresponding to anchor UE and assistant UE are concatenated in ascending (or descending) order based on the paired UEs' C-RNTI.

For a non-limiting example, when SR information is formed based on the ascending order of C-RNTI of paired UEs, and when the C-RNTI of UE1 is smaller than the C-RNTI of UE2. The formed SR information includes at least one of the following three situations: ‘01’ indicates that UE1 has no scheduled requirement, but UE2 has the scheduled requirement; “10” indicates that UE1 has the scheduled requirement, but UE2 has no scheduled requirement; and/or ‘11’ indicates that UE1 has the scheduled requirement, and UE2 also has the scheduled requirement.

In some implementations, the formed SR information is modulated by using QPSK to obtain the modulated SR information. The modulated SR information is modulated into a configured (or predefined) sequence to obtain the modulated SR sequence. The modulated SR sequence is transmitted in the SR resource from the shared SR resource.

In some implementations, the base station and UE may agree on an SR sequence, and the modulated SR information can be modulated into the SR sequence. Alternatively, the base station can configure an SR sequence (denoted as n0, where n0 is the sequence index and the range of n0 0~11) through signaling, and the modulated SR information can be modulated into the SR sequence.

In some implementations, the SR sequence is transmitted in the SR resource based on PUCCH format 1. The UE1 and UE2 need to interact with each other's SR information.

In some implementations, SR sequences may be transmitted simultaneously. In some implementations, the UE1 and UE2 can simultaneously transmit the same modulated SR sequence within the same SR resource.

For a non-limiting example, the UE1 and UE2 interact with each other's SR information. The UE1 and UE2 respectively determine the modulated SR sequence based on the above method. Then the UE1 and UE2 simultaneously transmit the modulated SR sequence in the SR resource. The base station receives and parses the modulated SR sequence, and obtains one of the three situations mentioned above.

This transmission method is beneficial for improving the reliability of SR transmission. For example, the paired UEs at the edge of the cell can consider using this transmission method.

Alternatively, after UE1 (or UE2) determines the modulated SR sequence based on the above method, UE1 (or UE2) notifies the modulated SR sequence to UE2 (or UE1), and then UE1 and UE2 simultaneously transmit the modulated SR sequence in the SR resource.

In some implementations, the base station can configure the transmission mode of the SR sequence in the same SR resource through signaling. For example, the base station can configure the final SR sequence to be transmitted simultaneously by the UE1 and UE2, or the base station can configure the final SR sequence to be transmitted by the UE1 or the UE2.

In some implementations, the base station and UE agree that one of the aforementioned transmission modes is executed by default, and the base station can configure another transmission mode through signaling to replace the default transmission mode.

In some implementations, the UE1 or UE2 can send signaling to the base station to request a certain transmission mode. For example, when paired UEs are located at the edge of the cell, the paired UEs can request UE1 and UE2 to simultaneously transmit the modulated SR sequence. For example, when the remaining power of UE1 is low, the paired UEs can request only UE2 to transmit the modulated SR sequence. The base station configures the corresponding transmission modes for UE1 and UE2 based on the request information.

In some implementations, the SR information of paired UEs is ultimately transmitted based on PUCCH format 1. Here, the SR information of the paired UEs is modulated in the same SR sequence, and the base station can obtain the state of the SR information of the paired UEs from the received SR sequence through reverse operation.

In some implementations, for more than two UEs in UE aggregation, the SR information of these UEs is also concatenated based on their C-RNTI ascending or descending order. The SR information that is concatenated is modulated to obtain the modulated SR information. The modulated SR information is transmitted in the SR resource from the shared SR resources based on PUCCH format 2, PUCCH format 3, or PUCCH format 4.

In some implementations, the modulated SR information can be transmitted by one of the paired UEs, or by multiple paired UEs simultaneously within the same SR resource.

### Embodiment Set III

In some embodiments, the paired UE1 and UE2 are configured to share a SR configuration and share SR resources corresponding to the SR configuration. When the UE1 and/or UE2 have the scheduled requirement, the UE1 and/or UE2 respectively transmit their respective configured (SR) sequence in the same or different SR resources from the shared SR resources. The SR sequence may indicate that UE1 and/or UE2 have scheduled requirements.

In some implementations, when the UE1 and/or UE2 have scheduled requirement, the UE1 and/or UE2 respectively transmit their respective configured sequence (denoted as u0) in the same or different SR resources from the shared SR resources.

In some implementations, after the base station receives and parses the configured sequence, one of the following situations may be obtained: 1) the UE1 has a scheduled requirement; and/or 2) the UE2 has a scheduled requirement.

In some implementations, when the base station does not receive the configured sequence, the base station considers that neither UE1 nor UE2 needs to be scheduled, that is, neither UE1 nor UE2 needs to be scheduled. Correspondingly, when both UE1 and UE2 have no scheduled requirements, UE1 and UE2 do not transmit the configured sequence in the SR resource.

In some implementations, the SR sequence may be configured by the following. Different sequence (u0) may be configured separately for the paired UE1 and UE2 as their respective SR sequences. When the UE1 (or UE2) has a scheduled requirement, then UE1 (or UE2) transmits the corresponding configured SR sequence in the SR resource from the shared SR resources.

In some implementations, when both UE1 and UE2 have the scheduled requirements, UE1 and UE2 respectively transmit their respective configured SR sequences in the same or different SR resources from the shared SR resources.

In some implementations, in order to determine the scheduled requirements for UE1 and UE2, the base station always needs to separately parse the received SR sequence for UE1 and UE2. When neither UE1 nor UE2 has a scheduled demand, then UE1 and UE2 do not transmit the corresponding SR sequence in the SR resource.

In some implementations, the UE1 and UE2 do not need to interact with each other's SR information.

In some implementations, the configured SR sequence may be transmitted by the following.

In some implementations, when the UE1 has a scheduled requirement, the configured SR sequence of UE1 can be transmitted by UE2 in the SR resource from the shared SR resources. In this case, the base station receives the SR sequence of UE1 from the SR resource, and the base station believes that UE1 has a scheduled requirement. It is beneficial for UE1 to save electricity.

In some implementations, when the UE2 has a scheduled requirement, the configured SR sequence of UE2 can be transmitted by UE1 in the SR resource from the shared SR resources. In this case, the base station receives the SR sequence of UE2 from the SR resource, and the base station believes that UE2 has a scheduled requirement. It is beneficial for UE2 to save electricity.

In some implementations, when the UE1 has a scheduled requirement, the configured SR sequence of UE1 can be simultaneously transmitted by UE1 and UE2 in the same SR resource from the shared SR resources. In this case, the base station receives the SR sequence of UE1 from the SR resource, and the base station believes that UE1 has a scheduled requirement. In this case, it is beneficial to improve the reliability and coverage of UE1's SR sequence.

In some implementations, when the UE2 has a scheduled requirement, the configured SR sequence of UE2 can be simultaneously transmitted by UE1 and UE2 in the same SR resource from the shared SR resources. In this case, the base station receives the SR sequence of UE2 from the SR resource, and the base station believes that UE2 has a scheduled requirement. In this case, it is beneficial to improve the reliability and coverage of UE2's SR sequence.

In some implementations, the base station can configure the transmission mode of the UE1's (or UE2's) SR sequence in the same SR resource through signaling. For example, the base station can configure the UE1's (or UE2's) SR sequence to be transmitted simultaneously by UE1 and UE2, or the base station can configure the UE1's (or UE2's) SR sequence to be transmitted by UE1 or UE2. Alternatively, the base station and UE agree that one of the aforementioned transmission modes is executed by default, and the base station can configure another transmission mode through signaling to replace the default transmission mode.

Alternatively, UE1 or UE2 can send signaling to the base station to request a certain transmission mode. For example, when paired UEs are located at the edge of the cell, the paired UEs can request UE1 and UE2 to simultaneously transmit the UE1's (or UE2's) SR sequence. For example, when the remaining power of UE1 (or UE2) is low, the paired UEs can request only UE2 (or UE1) to transmit the UE1's (or UE2's) SR sequence. The base station configures the corresponding transmission modes for UE1 and UE2 based on the request information.

In some implementations, the SR information of UE1 (or UE2) is transmitted based on PUCCH format 0. Here, the states of SR information of UE1 and UE2 correspond to their respective configured SR sequences. The base station can obtain the state of the SR information of UE1 and/or UE2 from the received SR sequence through reverse operation.

In some implementations, for more than two UEs in UE aggregation, different SR sequences are configured separately for these UEs, and UEs with scheduled requirements can directly transmit the corresponding SR sequences in the same SR resource based on PUCCH format 0.

### Embodiment Set IV

In some embodiments, the paired UE1 and UE2 are configured to share a SR configuration and share SR resources corresponding to the SR configuration. When the UE1 and/or UE2 have the scheduled requirement, the UE1 and/or UE2 respectively transmit their respective configured (SR) sequence in the same or different SR resources from the shared SR resources, and the transmitted (SR) sequence is modulated by the SR information of UE1 and/or UE2. The SR sequence can indicate that UE1 and/or UE2 have scheduled requirements.

In some implementations, when the UE1 and/or UE2 have scheduled requests, UE1 and/or UE2 respectively modulate their respective SR information into the configured (SR) sequence (denoted as w0) and transmit the modulated sequence separately in the same or different SR resource from the shared SR resources.

In some implementations, the base station receives and parses the modulated sequence, one of the following situations can be obtained: 1) UE1 has a scheduled requirement; and/or 2) UE2 has a scheduled requirement.

In some implementations, when the base station does not receive the modulated sequence, the base station considers that neither UE1 nor UE2 needs to be scheduled, that is, neither UE1 nor UE2 needs to be scheduled. Correspondingly, when both UE1 and UE2 have no scheduled requirements, UE1 and UE2 do not transmit the modulated sequence in the SR resource.

In some implementations, the SR sequence may be configured by the following.

In some implementations, different sequence (w0) are configured separately for the paired UE1 and UE2 as their respective SR sequences. When the UE1 (or UE2) has a scheduled requirement, the UE1 (or UE2) transmits the corresponding configured SR sequence in the SR resource from the shared SR resources.

In some implementations, when both UE1 and UE2 have the scheduled requirements, UE1 and UE2 respectively transmit their respective configured SR sequences in the same or different SR resources from the shared SR resources.

In some implementations, in order to determine the scheduled requirements for UE1 and UE2, the base station always needs to separately parse the received SR sequence for UE1 and UE2. When neither UE1 nor UE2 has a scheduled demand, then UE1 and UE2 do not transmit the corresponding SR sequence in the SR resource.

In some implementations, the UE1 and UE2 do not need to interact with each other's SR information.

In some implementations, the modulated SR sequence may be transmitted by the following.

In some implementations, when the UE1 has a scheduled requirement, the modulated SR sequence of UE1 can be transmitted by UE2 in the SR resource from the shared SR resources. In this case, the base station receives the SR sequence of UE1 from the SR resource, and the base station believes that UE1 has a scheduled requirement. It is beneficial for UE1 to save electricity.

In some implementations, when the UE2 has a scheduled requirement, the modulated SR sequence of UE2 can be transmitted by UE1 in the SR resource from the shared SR resources. In this case, the base station receives the SR sequence of UE2 from the SR resource, and the base station believes that UE2 has a scheduled requirement. It is beneficial for UE2 to save electricity.

In some implementations, when the UE1 has a scheduled requirement, the modulated SR sequence of UE1 can be simultaneously transmitted by UE1 and UE2 in the same SR resource from the shared SR resources. In this case, the base station receives the SR sequence of UE1 from the SR resource, and the base station believes that UE1 has a scheduled requirement. In this case, it is beneficial to improve the reliability and coverage of UE1's SR sequence.

In some implementations, when the UE2 has a scheduled requirement, the modulated SR sequence of UE2 can be simultaneously transmitted by UE1 and UE2 in the same SR resource from the shared SR resources. In this case, the base station receives the SR sequence of UE2 from the SR resource, and the base station believes that UE2 has a scheduled requirement. In this case, it is beneficial to improve the reliability and coverage of UE2's SR sequence.

In some implementations, the base station can configure the transmission mode of the UE1's (or UE2's) modulated SR sequence in the same SR resource through signaling. For example, the base station can configure to transmit the UE1's (or UE2's) modulated SR sequence simultaneously by UE1 and UE2, or the base station can configure to transmit the UE1's (or UE2's) modulated SR sequence by UE1 or UE2. Alternatively, the base station and UE agree that one of the aforementioned transmission modes is executed by default, and then the base station can configure another transmission mode through signaling to replace the default transmission mode.

In some implementations, the UE1 or UE2 can send signaling to the base station to request a certain transmission mode. For example, when paired UEs are located at the edge of the cell, the paired UEs can request UE1 and UE2 to simultaneously transmit the UE1's (or UE2's) modulated SR sequence. For example, when the remaining power of UE1 (or UE2) is low, the paired UEs can request only UE2 (or UE1) to transmit the UE1's (or UE2's) modulated SR sequence. The base station configures the corresponding transmission modes for UE1 and UE2 based on the request information.

In some implementations, the SR information of UE1 (or UE2) is transmitted based on PUCCH format 1. Here, the states of SR information of UE1 and UE2 are respectively modulated into their respective configured SR sequences. The base station can obtain the state of the SR information of UE1 and/or UE2 from the modulated SR sequence through reverse operation.

In some implementations, when there are more than 2 paired UEs, different SR sequences are configured separately for these UEs, and UEs with scheduled requirements can modulate the SR information into the their respective configured SR sequence, and transmit the modulated SR sequence in the same SR resource based on PUCCH format 1.

The various implementations in the Embodiment Set I and Embodiment Set III may be independently supported for paired UEs, or can be effectively combined for paired UEs. For example, when only one UE in paired UEs needs to transmit an SR sequence, the method in Embodiment Set III can be executed. For example, when paired UEs simultaneously need to transmit SR sequences, the method in Embodiment Set I can be executed.

The various implementations in the Embodiment Set II and Embodiment Set IV may be independently supported for paired UEs, or can be effectively combined for paired UEs. For example, when only one UE in paired UEs needs to transmit an SR sequence, the method in Embodiment Set IV can be executed. For example, when paired UEs simultaneously need to transmit SR sequences, the method in Embodiment Set II can be executed.

### Embodiment Set V

In various embodiments, the paired UE1 and UE2 are configured to share a SR configuration and share SR resources corresponding to the SR configuration. When the UE1 has the scheduled requirement, UE1 and/or UE2 transmit a shared (SR) sequence in the shared SR resources. The shared SR sequence can indicate that UE1 has the scheduled requirement.

In some implementations, when the UE1 has scheduled requirement, UE1 and/or UE2 transmit the shared sequence (denoted as s0) in the shared SR resources.

In some implementations, after the base station receives and parses the shared sequence, one of the following situations can be obtained: 1) UE1 has a scheduled requirement.

In some implementations, when the base station does not receive the shared sequence, the base station considers that UE1 does not need to be scheduled. Correspondingly, when UE1 has no scheduled requirement, UE1 and/or UE2 do not transmit the shared sequence in the shared SR resource.

In some implementations, the shared SR sequence may be configured by the following.

In some implementations, a sequence (s0) is configured for the paired UE1 and UE2 as UE1's SR sequence (e.g., anchor UE). The configured sequence can be called a shared sequence. When the UE1 has a scheduled requirement, the UE1 and/or UE2 transmit the shared SR sequence in the shared SR resources.

In some implementations, the UE1 and UE2 need to interact with each other's SR information.

In some implementations, the configured SR sequence may be transmitted by the following.

In some implementations, when the UE1 has a scheduled requirement, the shared SR sequence of UE1 can be transmitted by UE2 in the SR resource from the shared SR resources. In this case, the base station receives the shared SR sequence of UE1 from the SR resource, and the base station believes that UE1 has a scheduled requirement. It is beneficial for UE1 to save electricity.

In some implementations, when the UE1 has a scheduled requirement, the shared SR sequence of UE1 can be simultaneously transmitted by UE1 and UE2 in the same SR resource from the shared SR resources. In this case, the base station receives the SR sequence of UE1 from the SR resource, and the base station believes that UE1 has a scheduled requirement. In this case, it is beneficial to improve the reliability and coverage of UE1's SR sequence.

In some implementations, the base station can configure the transmission mode of the UE1's shared SR sequence in the same SR resource through signaling. For example, the base station can configure to transmit the UE1's shared SR sequence simultaneously by UE1 and UE2, or the base station can configure to transmit the UE1's shared SR sequence by UE1 or UE2. Alternatively, the base station and UE agree that one of the aforementioned transmission modes is executed by default, and then the base station can configure another transmission mode through signaling to replace the default transmission mode.

In some implementations, the UE1 or UE2 can send signaling to the base station to request a certain transmission mode. For example, when paired UEs are located at the edge of the cell, the paired UEs can request UE1 and UE2 to simultaneously transmit the UE1's shared SR sequence. For example, when the remaining power of UE1 (or UE2) is low, the paired UEs can request only UE2 (or UE1) to transmit the UE1's shared SR sequence. The base station configures the corresponding transmission modes for UE1 and UE2 based on the request information.

In some implementations, the shared SR information of UE1 is transmitted based on PUCCH format 0. Here, the states of SR information of UE1 correspond to the shared SR sequences. The base station can obtain the state of the SR information of UE1 from the received SR sequence through reverse operation.

### Embodiment Set VI

In some embodiments, the paired UE1 and UE2 are configured to share a SR configuration and share SR resources corresponding to the SR configuration. When the UE1 has the scheduled requirement, the UE1 and/or UE2 transmit a shared (SR) sequence in the shared SR resources. The transmitted (SR) sequence is modulated by the SR information of UE1. The shared SR sequence can indicate that the UE1 has the scheduled requirement.

In some implementations, when the UE1 has scheduled requirement, UE1 and/or UE2 respectively modulate UE1's SR information into the shared (SR) sequence (denoted as e0) and transmit the shared sequence (denoted as e0) in the shared SR resources.

In some implementations, after the base station receives and parses the shared sequence, one of the following situations can be obtained: 1) UE1 has a scheduled requirement.

In some implementations, when the base station does not receive the shared sequence, the base station considers that UE1 does not need to be scheduled. Correspondingly, when the UE1 has no scheduled requirement, UE1 and/or UE2 do not transmit the shared sequence in the shared SR resource.

In some implementations, the shared SR sequence may be configured by the following.

In some implementations, a sequence (e0) is configured for the paired UE1 and UE2 as UE1's SR sequence (anchor UE). The configured sequence can be called a shared sequence. When the UE1 has a scheduled requirement, the UE1 and/or UE2 modulate and transmit the shared SR sequence in the shared SR resources.

In some implementations, the UE1 and UE2 need to interact with each other's SR information.

In some implementations, the configured SR sequence may be transmitted by the following.

In some implementations, when the UE1 has a scheduled requirement, the shared SR sequence of UE1 can be transmitted by UE2 in the SR resource from the shared SR resources. In this case, the base station receives the shared SR sequence of UE1 from the SR resource, and the base station believes that UE1 has a scheduled requirement. It is beneficial for UE1 to save electricity.

In some implementations, when the UE1 has a scheduled requirement, the shared SR sequence of UE1 can be simultaneously transmitted by UE1 and UE2 in the same SR resource from the shared SR resources. In this case, the base station receives the SR sequence of UE1 from the SR resource, and the base station believes that UE1 has a scheduled requirement. In this case, it is beneficial to improve the reliability and coverage of UE1's SR sequence.

In some implementations, the base station can configure the transmission mode of the UE1's shared SR sequence in the same SR resource through signaling. For example, the base station can configure to transmit the UE1's shared SR sequence simultaneously by UE1 and UE2, or the base station can configure to transmit the UE1's shared SR sequence by UE1 or UE2. Alternatively, the base station and UE agree that one of the aforementioned transmission modes is executed by default, and then the base station can configure another transmission mode through signaling to replace the default transmission mode.

In some implementations, the UE1 or UE2 can send signaling to the base station to request a certain transmission mode. For example, when paired UEs are located at the edge of the cell, the paired UEs can request UE1 and UE2 to simultaneously transmit the UE1's shared SR sequence. For example, when the remaining power of UE1 (or UE2) is low, the paired UEs can request only UE2 (or UE1) to transmit the UE1's shared SR sequence. The base station configures the corresponding transmission modes for UE1 and UE2 based on the request information.

In some implementations, the shared SR information of UE1 is transmitted based on PUCCH format 1. Here, the states of SR information of UE1 is modulated into the shared SR sequences. The base station can obtain the state of the SR information of UE1 from the received SR sequence through reverse operation.

### Embodiment Set VII

Various embodiments describe determination of shared SR resources, which may be applicable for Embodiment Sets I-VI. In some implementations, the shared SR resources are configured to include one of the following.

In some implementations, the UE1 is configured with one or more sets of SR resources based on SR configuration information, while UE2 is configured to share UE1's configured SR resources. The base station and UE agree that UE2 defaults to using UE1's configured SR resources. Alternatively, the base station instructs UE2 to use the configured SR resources of UE1 through signaling. Alternatively, the base station can configure UE2 with the same SR resources as UE1 through signaling. Alternatively, a new RRC signaling is introduced and used to configure a common set or sets of SR resources for UE1 and UE2.

In some implementations, the UE2 is configured with one or more sets of SR resources based on SR configuration information, while UE1 is configured to share UE2's configured SR resources. The base station and UE agree that UE1 defaults to using UE2's configured SR resources. Alternatively, the base station instructs UE1 to use the configured SR resources of UE2 through signaling. Alternatively, the base station can configure UE1 with the same SR resources as UE2 through signaling. Alternatively, a new RRC signaling is introduced and used to configure a common set or sets of SR resources for UE1 and UE2.

Various embodiments describe implicit identification of anchor UE and assistant UE. In some implementations, the base station and UE agree in advance that from the paired UEs, the anchor UE or assistant UE is determined to be based on the SR sequence or SR request transmitted in the configured shared SR resource.

In some implementations, this method is suitable for paired UEs to be anchor UE and assistant UE to each other. Alternatively, the paired UEs are always assumed to be anchor UE and assistant UE to each other, and anchor UE and assistant UE are determined based on the sending and receiving of corresponding SR request.

For a non-limiting example, the UE1 and UE2 are paired for UE aggregation transmission and configured to share SR resources. When UE1's scheduled request is sent in the shared SR resource, after receiving UE1's scheduled request, the base station considers that UE1 is an anchor UE and UE2 is an assistant UE, and UE2 transmits UE1's data. When the scheduled request of UE2 is sent in the shared SR resource, after receiving the scheduled request of UE2, the base station considers that UE2 is an anchor UE and UE1 is an assistant UE, and UE1 transmits UE2's data. In this way, the paired UEs may not report pairing information. For the paired UEs, the UE can indirectly notify the base station about the UE's role in the paired UEs by transmitting the scheduled request in the configured shared SR resource.

Various embodiments describe transmission methods for different uplink (UL) channels of aggregated UEs. In some implementations, the UE1 and UE2 are paired for UE aggregation transmission, and UE2 transmits UE1's data (including uplink control information, UCI). UCI may include at least one of the following: HARQ-ACK, SR, and/or CSI. This method may be described with the following cases and/or options.

For Case One (“Case1” or “Case 1”): in slot n, the UE1's PUCCH1 (used to carry UCI) wants to be transmitted by UE1, while UE1's PUSCH1 also wants to be transmitted by UE1, and PUCCH1 and PUSCH1 overlap in the time domain.

In some implementations, the solution may include the UCI in PUCCH1 is multiplexed into PUSCH1, PUSCH1 is transmitted by UE1, and PUCCH1 is not transmitted (cancelled) by UE1. This method is beneficial for reducing the complexity of UE1 transmission, such as UE1 only transmitting one uplink channel without the need to transmit two uplink channels simultaneously.

In some implementations, the PUCCH1 and PUSCH1 have the same priority.

In some implementations, for the above Case 1, based on UE aggregation transmission, one of the following options (solutions) may be used.

Option 1: PUSCH1 of UE1 is transmitted by UE2, and PUCCH1 of UE1 is transmitted by UE1. In this way, UE1 still only transmits one uplink channel.

Option 2: PUCCH1 of UE1 is transmitted by UE2, and PUSCH1 of UE1 is transmitted by UE1. In this way, UE1 still only transmits one uplink channel.

Option 3: The UCI in PUCCH1 of UE1 is multiplexed in PUSCH1, but the multiplexed result PUSCH1 is transmitted by UE2. This method can be used to save electricity for UE1.

Option 4: The UCI in PUCCH1 of UE1 is multiplexed in PUSCH1, and the multiplexing result PUSCH1 is transmitted simultaneously by UE1 and UE2. This method is suitable for improving transmission reliability when UE1 and UE2 are located at the edge of the cell.

In Case1, the base station and UE agree to use one of the above methods; alternatively, the base station can configure UE to use one of the above methods.

In Case 1, the base station can receive PUCCH1 or PUSCH1 from UE1 and/or UE2 and perform reverse operations to obtain PUSCH1 and UCI in PUCCH1. The processing on the base station side will not be repeated.

The PUCCH1 here can also include the SRS (Sounding Reference Signal) signal of UE1.

For Case Two (“Case2” or “Case 2”): in slot n, the UE1's PUCCH1 (used to carry UCI) wants to be transmitted by UE1, while UE1's PUSCH1 also wants to be transmitted by UE1, with PUCCH1 and PUSCH1 overlapping in the time domain. PUCCH1 and PUSCH1 have different priorities.

In some implementations, for the above Case 2, one solution may include the following. When the UE1 is not configured to reuse different priority PUCCH and PUSCH through signaling, then between the two channels of PUCCH1 and PUSCH1, the channel with higher priority is transmitted by UE1, and the channel with lower priority is not transmitted (cancelled) by UE1. This approach is beneficial for reducing the complexity of UE transmission, such as UE1 only transmitting one uplink channel without the need to simultaneously transmit two uplink channels.

For the above Case 2, based on UE aggregation transmission, one of the following methods can be used:

Option 5: PUSCH1 of UE1 is transmitted by UE2, and PUCCH1 of UE1 is transmitted by UE1. In this way, UE1 still only transmits one uplink channel.

Option 6: PUCCH1 of UE1 is transmitted by UE2, and PUSCH1 of UE1 is transmitted by UE1. In this way, UE1 still only transmits one uplink channel.

Option 7: Between the two channels of PUCCH1 and PUSCH1, the channel with higher priority is transmitted by UE2, and the channel with lower priority is transmitted by UE1. In this way, UE1 still only transmits one uplink channel.

Option 8: Between the two channels of PUCCH1 and PUSCH1, the channel with higher priority is transmitted by UE1, and the channel with lower priority is transmitted by UE2. In this way, UE1 still only transmits one uplink channel.

In Case2, the base station and UE agree to use one of the above methods; alternatively, the base station can configure UE to use one of the above methods.

In some implementations, in Case 2, the base station can receive PUCCH1 or PUSCH1 from UE1 and/or UE2 and perform reverse operations to obtain PUSCH1 and UCI in PUCCH1. The base station side may perform actions, as described in the present disclosure.

In some implementations, the PUCCH1 may include the SRS signal of UE1.

The present disclosure describes methods, apparatus, and computer-readable medium for wireless communication. The present disclosure addressed the issues with generating and transmitting SR under UE aggregation transmission. The methods, devices, and computer-readable medium described in the present disclosure may facilitate the performance of wireless communication, thus improving efficiency and overall performance. The methods, devices, and computer-readable medium described in the present disclosure may improves the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM (Read only memory). The software implementing various embodiments of the present disclosure can be stored in such devices and executed by a processor (or processing circuitry). A computer-readable medium can include one or more memory devices or chips, according to particular needs. The software can cause the processor (including CPU (central processing unit), GPU (graphics processing unit), FPGA (field-programmable gate array), and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments, for non-limiting examples, a portion from one or more embodiment may be combined with another portion of other embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method for wireless communication, comprising:
receiving, by at least one of a first user equipment (UE) and a second UE from a base station, a shared scheduling request (SR) configuration, wherein the first UE and the second UE are paired for an UE aggregation transmission;
configuring, by at least one of the first UE and the second UE, shared SR resources corresponding to the shared SR configuration;
forming, by at least one of the first UE and the second UE, SR information according to scheduled requirement status of at least one of the first UE and the second UE;
determining, by at least one of the first UE and the second UE, an SR sequence based on the SR information; and
transmitting, by at least one of the first UE and the second UE to the base station, the SR sequence in a SR resource from the shared SR resources.

2. (canceled)

3. The method according to claim 1, wherein: the forming the SR information according to scheduled requirement status of at least one of the first UE and the second UE and the determining the SR sequence based on the SR information comprises:
in response to the first UE having scheduled requirement and the second UE not having scheduled requirement, determining, by the first UE, a first pre-configured SR sequence as the first UE's SR sequence;
in response to the first UE not having scheduled requirement and the second UE having scheduled requirement, determining, by the second UE, a second pre-configured SR sequence as the second UE's SR sequence; or
in response to the first UE and the second UE having scheduled requirement, determining, by the first UE and the second UE, a first pre-configured SR sequence as the first UE's SR sequence and a second pre-configured SR sequence as the second UE's SR sequence, respectively.

4. The method according to claim 3, wherein the transmitting the SR sequence in the SR resource from the shared SR resources comprises:
in response to the first UE having scheduled requirement and the second UE not having scheduled requirement:
transmitting, by the first UE, the first UE's SR sequence in the SR resource,
transmitting, by the second UE, the first UE's SR sequence in the SR resource, or
transmitting, by the first UE and the second UE simultaneously, the first UE's SR sequence in the same SR resource;
in response to the first UE not having scheduled requirement and the second UE having scheduled requirement:
transmitting, by the first UE, the second UE's SR sequence in the SR resource,
transmitting, by the second UE, the second UE's SR sequence in the SR resource, or
transmitting, by the first UE and the second UE simultaneously, the second UE's SR sequence in the same SR resource; or
in response to the first UE and the second UE having scheduled requirement, transmitting, by the first UE and the second UE, the first UE's SR sequence and the second UE's SR sequence, respectively, in a same or different SR resources.

5. The method according to claim 1, wherein
the first UE and the second UE are configured with a transmission mode, wherein the transmission mode is configured as one of the following:
a first mode wherein the first UE and the second UE transmit the SR sequence simultaneously,
a second mode wherein the first UE transmits the SR sequence, or
a third mode wherein the second UE transmits the SR sequence;
one transmission mode is configured as a default transmission mode; or at least one UE of the first UE and the second UE requests a transmission mode from the base station;
one of the first UE and the second UE is determined as an anchor UE;
wherein the transmitting the SR sequence in the SR resource comprises:
transmitting, by at least one of the first UE and the second UE, the SR sequence based on a physical uplink control channel (PUCCH) format 0; or
modulating, by at least one of the first UE and the second UE, the SR sequence to obtain a modulated SR sequence; and
transmitting, by at least one of the first UE and the second UE, the modulated SR sequence based on a PUCCH format 1.

6-9. (canceled)

10. The method according to claim 1, wherein: the forming the SR information according to scheduled requirement status of at least one of the first UE and the second UE and the determining the SR sequence based on the SR information comprises:
in response to the first UE having scheduled requirement, determining, by the first UE, a pre-configured SR sequence as the shared SR sequence, wherein the pre-configured SR sequence is configured for the paired first UE and second UE.

11. The method according to claim 10, wherein the transmitting the SR sequence in the SR resource comprises:
in response to the first UE having scheduled requirement:
transmitting, by the first UE, the shared SR sequence in the SR resource,
transmitting, by the second UE, the shared SR sequence in the SR resource, or
transmitting, by the first UE and the second UE simultaneously, the shared SR sequence in the same SR resource;
the first UE and the second UE are configured with a transmission mode, wherein the transmission mode is configured as one of the following:
a first mode wherein the first UE and the second UE transmit the shared SR sequence simultaneously,
a second mode wherein the first UE transmits the shared SR sequence, or
a third mode wherein the second UE transmits the shared SR sequence,
one transmission mode is configured as a default transmission mode; or at least one UE of the first UE and the second UE requests a transmission mode from the base station;
wherein the transmitting the SR sequence in the SR resource comprises:
transmitting, by at least one of the first UE and the second UE, the shared SR sequence based on a physical uplink control channel (PUCCH) format 0; or
modulating, by at least one of the first UE and the second UE, the shared SR sequence to obtain a modulated shared SR sequence; and
transmitting, by at least one of the first UE and the second UE, the modulated shared SR sequence based on a PUCCH format 1.

12-15. (canceled)

16. The method according to claim 1, wherein: the forming the SR information according to scheduled requirement status of at least one of the first UE and the second UE comprises:
determining, by at least one of the first UE and the second UE, a first bit based on the scheduled requirement status of the first UE and a second bit based on the scheduled requirement status of the second UE; and
forming, by at least one of the first UE and the second UE, the SR information based on the first bit and the second bit according to a cell-radio network temporary identifier (C-RNTI) of the first UE and the second UE.

17. The method according to claim 16, wherein:
in response to the first UE having scheduled requirement, the first bit is 1;
in response to the first UE not having scheduled requirement, the first bit is 0;
in response to the second UE having scheduled requirement, the second bit is 1; and
in response to the second UE not having scheduled requirement, the second bit is 0.

18. The method according to claim 16, wherein:
in response to the C-RNTI of the first UE being smaller than the C-RNTI of the second UE:
in response to the first UE not having scheduled requirement and the second UE having scheduled requirement, the SR information comprises two bits of 01;
in response to the first UE having scheduled requirement and the second UE not having scheduled requirement, the SR information comprises two bits of 10; and
in response to the first UE having scheduled requirement and the second UE having scheduled requirement, the SR information comprises two bits of 11.

19. The method according to claim 16, wherein the transmitting the SR sequence in the SR resource comprises:
transmitting, by the first UE, the SR sequence in the SR resource,
transmitting, by the second UE, the SR sequence in the SR resource, or
transmitting, by the first UE and the second UE simultaneously, the SR sequence in the same SR resource.

20. The method according to claim 16, wherein:
the first UE and the second UE are configured with a transmission mode, where the transmission mode is configured to as one of the following:
a first mode, wherein the first UE and the second UE transmit the SR sequence simultaneously,
a second mode, wherein the first UE transmits the SR sequence, or
a third mode, wherein the second UE transmits the SR sequence.

21. The method according to claim 16, wherein:
one transmission mode is configured as a default transmission mode; or
at least one UE of the first UE and the second UE requests a transmission mode from the base station.

22. The method according to claim 16, wherein the determining the SR sequence based on the SR information comprises:
determining the SR sequence based an initial sequence index and a sequence cyclic shift, wherein the initial sequence index is configured by the base station and the sequence cyclic shift is determined based on the SR information.

23. The method according to claim 22, wherein the transmitting the SR sequence in the SR resource comprises:
transmitting, by at least one of the first UE and the second UE, the SR sequence based on a physical uplink control channel (PUCCH) format 0.

24. The method according to claim 16, wherein the determining the SR sequence based on the SR information comprises:
modulating, by at least one of the first UE and the second UE, the SR information by using a quadrature phase shift keying (QPSK) scheme to obtain a modulated SR information; and
modulating, by at least one of the first UE and the second UE, the modulated SR information to obtain a modulated SR sequence.

25. The method according to claim 24, wherein the transmitting the SR sequence in the SR resource comprises:
transmitting, by at least one of the first UE and the second UE, the modulated SR sequence based on a physical uplink control channel (PUCCH) format 1.

26. The method according to claim 1, wherein:
the shared SR resources are configured to comprise at least one of the following:
the first UE is configured with at least one set of SR resources based on the SR configuration, and the second UE is configured to share the configured SR resources of the first UE as a default configuration;
the first UE is configured with at least one set of SR resources based on the SR configuration, and the second UE is configured to share the configured SR resources of the first UE via a signalling from the base station;
the first UE is configured with at least one set of SR resources based on the SR configuration, and the second UE is configured with the same SR resources as the first UE via a signalling from the base station; or
the first UE and the second UE are configured with a common set of SR resources via a radio resource control (RRC) signalling from the base station.

27. The method according to claim 1, wherein:
in response to the first UE's physical uplink control channel (PUCCH) and physical uplink shared channel (PUSCH) overlapping in a time domain, wherein the first UE's PUCCH comprises uplink control information (UCI):
the first UE transmits the first UE's PUCCH, and the second UE transmits the first UE's PUSCH;
the first UE transmits the first UE's PUSCH, and the second UE transmits the first UE's PUCCH;
the second UE transmits a multiplexed PUSCH, which is obtained by multiplexing the UCI in the first UE's PUCCH in the first UE's PUSCH; or
the first UE and the second UE simultaneously transmit a multiplexed PUSCH, which is obtained by multiplexing the UCI in the first UE's PUCCH in the first UE's PUSCH; and
in response to the first UE's PUCCH and PUSCH overlapping in a time domain, wherein the first UE's PUCCH comprises uplink control information (UCI) and the first UE's PUCCH and PUSCH have different priorities:
the first UE transmits the first UE's PUCCH, and the second UE transmits the first UE's PUSCH;
the first UE transmits the first UE's PUSCH, and the second UE transmits the first UE's PUCCH;
the first UE transmits a channel with lower priority between the first UE's PUCCH and PUSCH, and the second UE transmits another channel with higher priority between the first UE's PUCCH and PUSCH; or
the first UE transmits a channel with higher priority between the first UE's PUCCH and PUSCH, and the second UE transmits another channel with lower priority between the first UE's PUCCH and PUSCH.

28. A wireless communications apparatus comprising a processor and a memory, wherein the processor is configured to read code from the memory and implement a method comprising:
receiving, by at least one of a first user equipment (UE) and a second UE from a base station, a shared scheduling request (SR) configuration, wherein the first UE and the second UE are paired for an UE aggregation transmission;
configuring, by at least one of the first UE and the second UE, shared SR resources corresponding to the shared SR configuration;
forming, by at least one of the first UE and the second UE, SR information according to scheduled requirement status of at least one of the first UE and the second UE;
determining, by at least one of the first UE and the second UE, an SR sequence based on the SR information; and
transmitting, by at least one of the first UE and the second UE to the base station, the SR sequence in a SR resource from the shared SR resources.

29. (canceled)

30. A method for wireless communication, comprising:
sending, by a base station to at least one of a first user equipment (UE) and a second UE, a shared scheduling request (SR) configuration to configure shared SR resources, wherein the first UE and the second UE are paired for an UE aggregation transmission; and
receiving, by the base station from at least one of the first UE and the second UE, a SR sequence in a SR resource from the shared SR resources, wherein the at least one of the first UE and the second UE forms SR information according to scheduled requirement status of at least one of the first UE and the second UE, and determines the SR sequence based on the SR information.
